(19) United States
(12) Patent Application Publication
(10) Pub. No.: US 2026/0167442 A1
(43) Pub. Date: Jun. 18, 2026

(54) SYSTEM AND METHOD FOR AUTOMATICALLY LOADING PALLET BOARDS

(71) Applicant: Alliance Automation, LLC, Van Wert, OH (US)

(72) Inventors: Michael Etter, Van Wert, OH (US); Enoch Jones, Columbus Grove, OH (US); Karl Klopfenstein, Haviland, OH (US); Kevin Wentz, Portland, OH (US); Troy Bruggeman, Chickasaw, OH (US)

(21) Appl. No.: 19/421,952

(22) Filed: Dec. 16, 2025

Related U.S. Application Data
(60) Provisional application No. 63/734,515, filed on Dec. 16, 2024.

(51) Int. Cl. B65G 57/24; B65G 43/08; B65G 47/88; B65G 61/00

(52) U.S. Cl. CPC B65G 57/24; B65G 43/08; B65G 47/883; B65G 61/00; B65G 2201/0267; B65G 2203/0225; B65G 2203/041

(57) ABSTRACT

A board loading system includes at least one board loading cell configured to sort and load deck boards of a pallet. The board loading cell includes a robot having an end of tool configured to grasp and transport a layer of boards to a feed assembly including a sorting region where the boards are inspected and sorted. The sorting of the boards is performed by a board sorting mechanism and includes allowing passage of acceptable and properly oriented boards, reorienting acceptable and improperly oriented boards, and rejecting and removing unacceptable boards from the feed assembly. A transport conveyor is configured to transfer the acceptable boards towards a pallet assembly mechanism associated with the board loading system. A board positioning mechanism is disposed adjacent the pallet assembly mechanism and is configured to stack the acceptable boards at a desired orientation within a hopper of the pallet assembly mechanism.

### CROSS-REFERENCE TO RELATED APPLICATION

This patent application claims priority to U.S. Provisional Patent Application Ser. No. 63/734,515, filed on Dec. 16, 2025, the entire disclosure of which is hereby incorporated herein by reference.

### FIELD OF THE INVENTION

The invention relates generally to a system and method for assembling pallets, and more particularly, to a system and method for automatically sorting and orienting pallet boards and then loading such pallet boards for subsequent assembly via an associated pallet assembly mechanism.

### BACKGROUND

Since the development of the modern forklift in the early part of the twentieth century, the pallet has been relied upon as an efficient means of handling and transporting bulk goods and freight. The pallet is particularly desirable due to its relatively low cost to manufacture, as well as the abundance and renewability of the materials forming such pallets. For example, many pallets are formed from wood. According to the U.S. Forest Service, there are approximately two billion wooden pallets currently in circulation throughout the United States.

In modern day pallet manufacturing facilities, it is often desirable to automate various processes in order to increase output, minimize the introduction of defects, and increase safety by eliminating potentially dangerous or non-ergonomic aspects of the pallet manufacturing process. Such automation typically includes the introduction of one or more robotic or automated apparatuses suitable for repeatedly carrying out preselected tasks, wherein a control system is responsible for operation of each of the robotic or automated apparatuses associated with the pallet manufacturing process.

One pallet manufacturing process in need of automation includes the transport, sorting, and orienting of the various different types of boards that may be associated with the assembly of an associated pallet. Such pallets generally include multiple different types of boards having differing dimensions and/or configurations suitable for forming a desired pallet configuration upon assembly thereof. As one example, a stringer pallet may include the use of at least two different types of boards in assembling such a pallet such as deck boards and stringer boards, wherein the deck boards may be utilized in forming top and bottom decks (outermost layers) of the stringer pallet and the stringers may be utilized in connecting the top and bottom decks to one another while providing suitable spacing between the top and bottom decks as an intermediate layer of the pallet. Additionally, the stringer boards are typically structurally distinct from the deck boards utilized in forming such stringer pallets due to the inclusion of notches within one of the surfaces of such stringer boards, whereby it is critical that such notches have a predetermined position and orientation when coupled to the top and bottom decks to maintain operational use of such stringer pallets upon assembly thereof.

Regardless of the type of pallet being assembled, the corresponding pallet manufacturing process may include the use of various mechanisms wherein such pallet boards are in need of loading into what may be referred to as a board hopper or board magazine from which such boards are repeatedly removed when performing a corresponding assembly process. For example, such boards may be removed from the corresponding hopper or magazine, often by automated means, for locating such boards relative to another portion of the pallet being assembled before then utilizing a nailing or other coupling mechanism to attach the removed boards to the remaining portion of the pallet being assembled.

Such hoppers or magazines may rely upon the boards that are loaded therein being complete, free of substantial defects, and at the correct position and orientation to ensure that any associated automated process can be repeatedly and automatically performed without incident in a timely and efficient manner. For example, such hoppers or magazines may include a stacking of the boards loaded therein with each of the stacked boards having a preselected position and orientation suitable for performing the associated automated process, such as having specific surfaces of each such boards having preselected alignments and orientations within the hopper or magazine to promote an ease of removal of such boards from the hopper or magazine and then the proper positioning and orientation of such boards when introduced to the associated pallet assembly mechanism, such as the aforementioned nailing mechanism.

It is accordingly often critical to the corresponding pallet assembly process that the boards are loaded into such hoppers or magazines in the same manner for each assembly process cycle to avoid circumstances where the associated process is interrupted as a result of misalignment of such boards, an improper orientation of such boards, or the presence of undesirable defects or flaws within such boards.

It would therefore be desirable to produce an automated system for transporting, sorting, positioning, orienting, and loading such pallet boards within such hoppers or magazines for promoting the use of automated assembly processes with respect to such pallet boards.

### SUMMARY

In concordance with the instant disclosure, an automated system and method for assembling pallets is disclosed.

According to an embodiment of the present invention, a board loading system includes at least one board loading cell configured to sort and load boards. The board loading cell includes a robot having an end of arm tool configured to grasp and transport at least one board and a feed assembly including a receiving conveyor configured to receive the at least one board grasped and transported by the robot, a sorting region individually receiving one of the boards from the receiving conveyer, the sorting region including an inspection position where an inspection sensor inspects the one of the boards received from the receiving conveyor and a board sorting mechanism configured to sort the one of the boards having been scanned by the inspection sensor according to the scanning results associated therewith. The sorting of the one of the boards includes allowing passage of the one of the boards when determined to be acceptable and properly oriented, reorienting and allowing passage of the one of the boards when determined to be acceptable and improperly oriented, and rejecting the one of the boards for removal from the feed assembly when determined to be unacceptable. A transport conveyor is configured to transfer the acceptable boards towards an assembly mechanism associated with the board loading system.

According to another embodiment of the present invention, a board positioning mechanism includes a hopper in which boards are stacked and first and second positioning assemblies disposed at an upper region of the hopper or above the hopper. Each of the first and second positioning assemblies includes a support element adjustable between a first position for supporting boards thereon and a second position for allowing the boards to fall by gravity. The first and second positioning assemblies are disposed at substantially the same vertical height and spaced apart from one another in a longitudinal direction of the boards.

According to another embodiment of the present invention, a board funneling mechanism includes a transport conveyor transporting boards with the boards arranged to extend longitudinally in a direction perpendicular to the direction of travel of the transport conveyor. A funneling station is disposed along the pathway of the transport conveyor. The funneling station includes a stop element configured to stop one of the boards being transported by the transport conveyor at the funneling station, a conveyor assembly actuatable to selectively cause the stopped board to be translated in the longitudinal direction thereof, and a funneling structure aligned longitudinally with the board when stopped at the funneling station. The conveyor assembly selectively causes the stopped board to be translated in the longitudinal direction thereof into the funneling structure. The funneling structure is configured to orient the board for upright stacking within a hopper disposed below the funneling structure.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings:

FIG. 1 is a perspective view of a pallet loading system according to an embodiment of the present invention;

FIG. 2 is a perspective view of a boarding sorting cell of the pallet loading system;

FIGS. 3A and 3B show sensor assemblies of an end of arm tool of a robot;

FIG. 4 is a perspective view showing a feed assembly and transport conveyor of the board sorting cell in isolation;

FIG. 5 is a fragmentary view of a receiving conveyor of the feed assembly;

FIG. 6 is an elevational cross-sectional view through the feed assembly and the transport conveyor;

FIG. 7 is an elevational cross-sectional view through the transport conveyor while showing the feed assembly extending rearwardly therefrom;

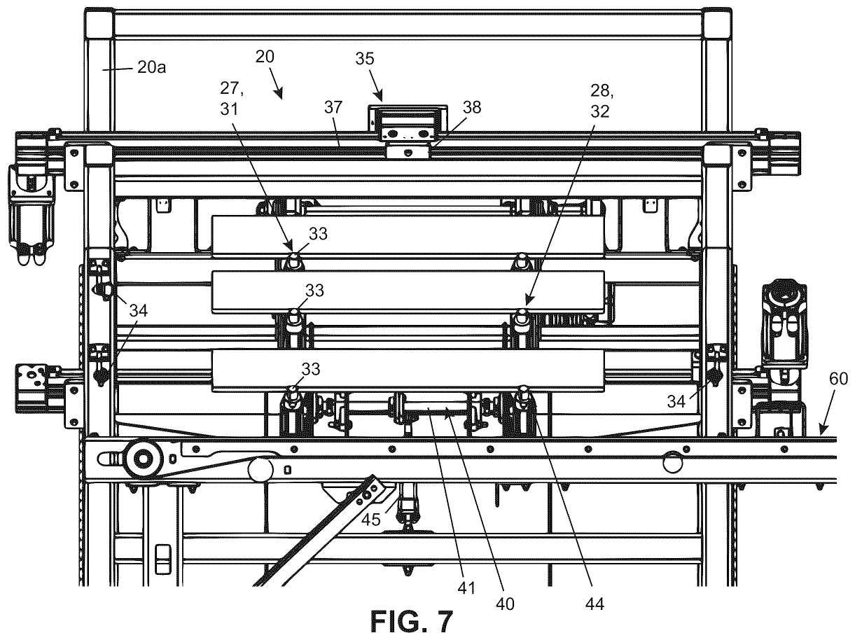

FIG. 8 is a perspective cross-sectional view showing a sorting region of the feed assembly;

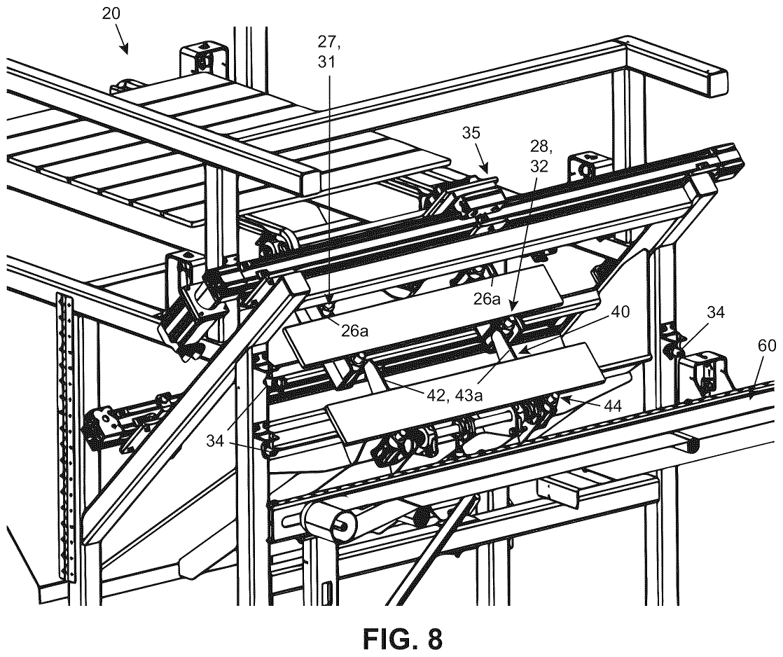

FIG. 9A is a perspective view of a board positioning mechanism according to an embodiment of the present invention;

FIG. 9B is an enlarged fragmentary perspective view of a positioning assembly of the board positioning mechanism of FIG. 9A;

FIG. 9C is a schematic representation of the process of the stacking of a board via the board positioning mechanism of FIG. 9A;

FIG. 9D is a perspective view of a board positioning mechanism according to another embodiment of the present invention;

FIG. 10 is a perspective view of a stringer loading cell according to an embodiment of the present invention;

FIGS. 11 and 12 are cross-sectional view showing the similarities between the feed assembly of the stringer loading cell of FIG. 10 and the feed assembly of the board loading cell of FIG. 4;

FIG. 13 is a perspective view of a stringer positioning mechanism according to an embodiment of the present invention;

FIG. 14 is a perspective cross-sectional view showing a funneling station of the stringer positioning mechanism; and

FIG. 15 is a top plan view of the stringer positioning mechanism.

### DETAILED DESCRIPTION OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

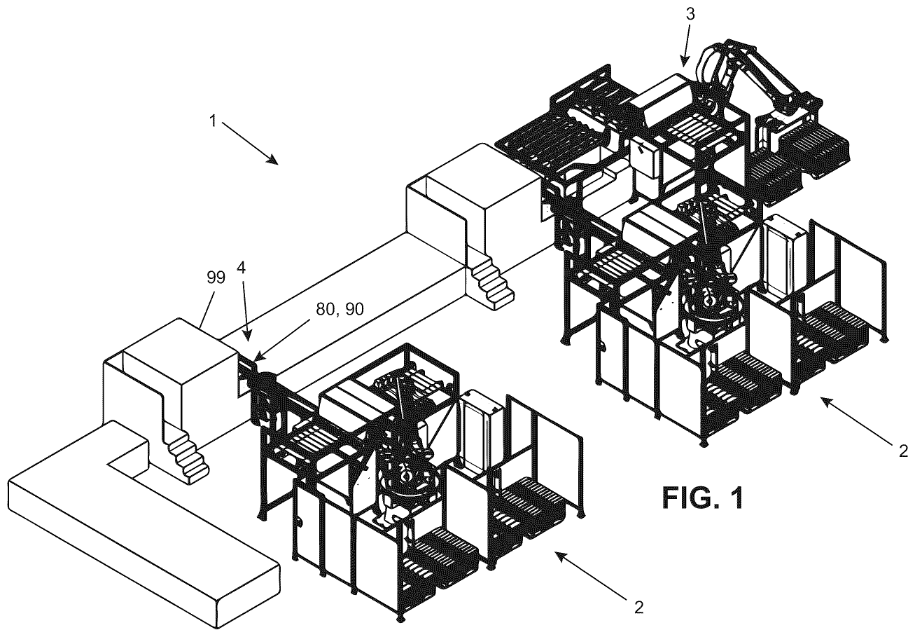

FIG. 1 illustrates a board loading system 1 according to an embodiment of the present invention. The board loading system 1 as shown and described is utilized in assembling a pallet. However, it should be readily apparent to one skilled in the art that the present invention may be utilized in any circumstance where a stacking of boards is desirable, and hence may be utilized in forming substantially any structure utilizing such stacked boards in addition to the described pallet, such as during the formation of structures such as crates, furniture, or the like. It should be understood that references to pallet forming mechanisms hereinafter may alternatively be considered to refer to any structure being assembled via the board loading system 1, hence the described application in forming pallets is merely exemplary in nature. The described systems and methods should also be readily understood to be adaptable for use with alternative materials or structures having a predefined shape capable of being transported and stacked in the manner described herein, such as alternative rectangular cuboid shaped structures or components in need of stacking in a desired orientation.

The board loading system 1 is illustrated as including two distinct deck board loading cells 2 and a single stringer loading cell 3, although different numbers and combinations of the loading cells 2, 3 may be utilized while remaining within the scope of the present invention. As described hereinafter, it should be assumed that the board loading system 1 is associated with one or more computing devices acting as one or more controllers of the board loading system 1, wherein each of the associated controllers is configured to provide selective operation/actuation of one or more of the components of the board loading system 1 as described hereinafter via some form of signal communication therebetween. That is, all actions and determinations described as occurring with respect to the components forming the board loading system 1 may be assumed to occur as a result of the utilization of such a controller absent description to the contrary. All sensors described hereinafter as being associated with operation of any of the components of the board loading system 1 should also be assumed to be in signal communication with a corresponding controller associated with making whatever determinations are based on the sensed condition derived from the corresponding sensor. The board loading system 1 may include any number of different controllers associated with different and distinct tasks, although the controller is described hereinafter as if only a single controller maintains operation of all components of the board loading system 1 for simplicity.

Each of the illustrated board loading cells 2 is configured to sort and load elongate boards having a substantially rectangular cuboid shape, wherein such boards may typically correspond to the deck boards of the pallet that form the uppermost layer (top deck) and the lowermost layer (bottom deck) of the associated pallet with respect to a height direction thereof. In contrast, the stringer loading cell 3 is configured to sort and load elongate boards having a rectangular cuboid shape along with a pair of notches removed from one of the long side surfaces thereof (provided for reception of a fork of a forklift within such notches), wherein such boards may typically correspond to the stringer boards of the pallet that are utilized in connecting the upper and lower decks with respect to the height direction of the pallet. It should be apparent to one skilled in the art that the loading cells 2, 3 may be adapted for the sorting and loading of substantially any types of boards associated with substantially any configuration or type of pallet or other structure without departing from the scope of the present invention as the eventual position of such boards within an assembled pallet is not necessarily critical to the operation of either of the loading cells 2, 3. That is, the loading cells 2, 3 may utilize the same or similar components as shown and described herein for sorting and loading boards of different shapes, configurations, or dimensions without departing from the scope of the present invention, and may perform such sorting and loading with respect to any form of assembly process performed with respect to any corresponding structure.

Each of the loading cells 2, 3 is generally configured to load the corresponding boards relative to a hopper or magazine associated with a pallet assembly mechanism (not shown), which may in some embodiments be a pallet nailing machine. A possible position for such a pallet assembly mechanism is shown via reference character 4 in FIG. 1. The hopper or magazine of the associated pallet assembly mechanism may be configured to feed individual ones of the boards to the pallet assembly mechanism for performing a corresponding assembly process. Where the pallet assembly mechanism is the pallet nailing machine, the boards may be fed to the pallet nailing machine from the hopper or magazine for coupling each respective board to other boards comprising the corresponding pallet. For example, the pallet nailing machine(s) may be configured to nail each of the deck boards forming one of the bottom deck or the top deck of the corresponding pallet to each of the stringers extending transversely between the bottom deck and the top deck, as one non-limiting example.

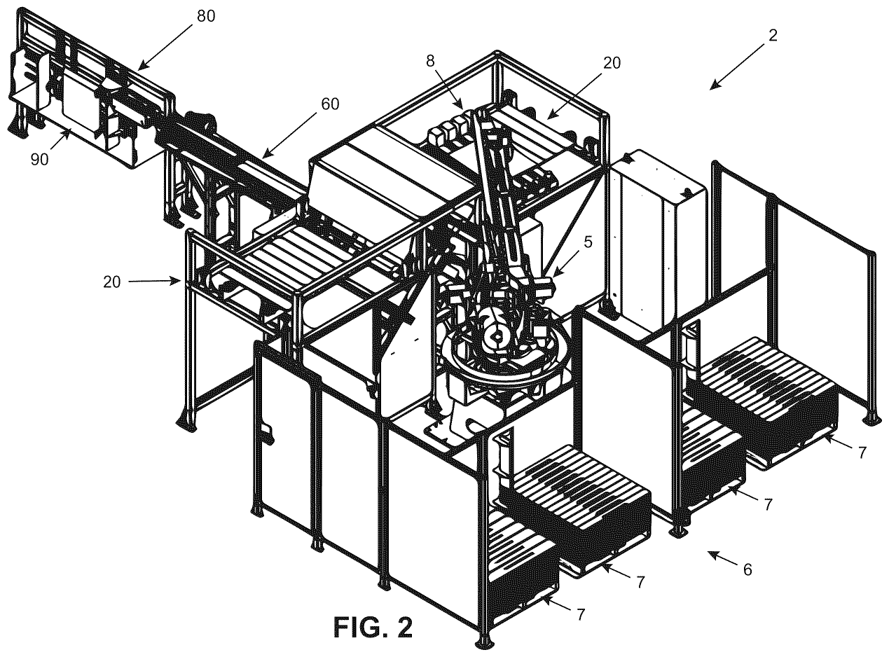

Referring now to FIG. 2, one of the board loading cells 2 is shown in isolation to more easily show the relevant features thereof. The board loading cell 2 includes a robot 5 disposed adjacent a lumber infeed region 6 having one or more bunks 7 of boards. The robot 5 may be a multi-axis robot capable of variably positioning and orienting an end of arm tool (EOAT) 8 thereof. The EOAT 8 may include a grasping mechanism for grasping a layer of multiple parallel arranged boards from one of the bunks 7 of the lumber infeed region 6. The grasping mechanism may be a vacuum grasping mechanism that utilizes suction along a planar surface for grasping an exposed layer of the boards of the corresponding bunk 7. However, alternative grasping means may be utilized while remaining within the scope of the present invention.

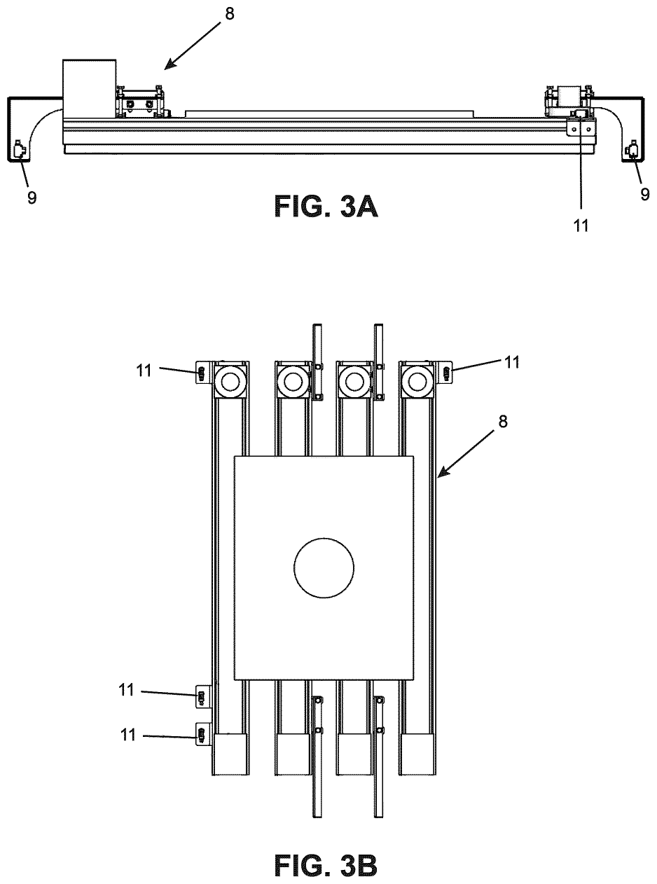

As shown in FIG. 3A, the EOAT 8 may include a gap detection sensor 9. The gap detection sensor 9 may include an emitter and a receiver and may utilize interference of a beam sent between the emitter and the receiver to determine whether a board or a gap is present therebetween. In the present embodiment, the emitter and the receiver are spaced apart from each other along a longitudinal dimension of the EOAT 8 with a beam directed therebetween extending in a direction that is intended to be arranged perpendicular to the direction of longitudinal extension of each of the boards of the uppermost exposed layer with respect to one of the bunks 7.

In some circumstances, the bunk 7 may include the use of alternating stacks of the layers of the boards with each of the adjacent stacks utilizing a perpendicular arrangement of the boards thereof, thereby requiring that the EOAT 8 be rotated 90 degrees when encountering a new stack to maintain the desired orientation of the grasping mechanism relative to the longitudinal direction of the boards of the new stack. The gap detection sensor 9 may be utilized to determine when this change in stacks occurs (corresponding to a change in direction of longitudinal extension of the boards of the uppermost exposed layer) via movement of the EOAT 8 relative to the uppermost exposed layer of boards while detecting whether the emitter/receiver pairing of the sensor 9 detects a continuous surface corresponding to detection of a longitudinal side of a single board or detects multiple gaps corresponding to the detection of multiple adjacent boards along a width direction of such boards. The sensor 9 can accordingly determine whether the EOAT 8 is oriented properly relative to the longitudinal direction of the boards or needs 90 degrees of rotation to properly grasp the next layer of boards.

As shown in FIG. 3B, an array of edge detecting sensors 11 may be disposed around an outer periphery of the EOAT 8 and may be configured to determine a center of the upper layer of exposed boards of the corresponding bunk 7 for centering the EOAT 8 relative to a perimeter shape thereof. That is, determining a position of multiple edges of the perimeter shape of the upper layer of exposed boards allows the EOAT 8 to be centered relative to the upper layer of exposed boards. Each of the edge detecting sensors 11 may direct a beam downwardly (outwardly) in a direction perpendicular to the plane of the grasping mechanism of the EOAT 8 and may utilize interruption/reflection of the beam during movement of the EOAT 8 in performing an edge detection process. Each of the edge detecting sensors 11 may accordingly include the integration of both an emitter and a receiver therein. The process of determining the position of such edges may include the EOAT 8 and corresponding sensors 11 moving horizontally in directions relative to the expected positions of such edges while monitoring the interruption/reflection of the corresponding beams, which may include horizontal movement in perpendicular arranged directions for determining the positions of perpendicular arranged edges, until the necessary edges are discovered by the edge detecting sensors 11 and utilized in determining at least a portion of a perimeter shape of the upper layer of exposed boards.

In some circumstances, only two perpendicular arranged edges may need to be discovered and utilized in determining the position of a corner of the perimeter shape where the two discovered edges meet so long as the dimensions of the perimeter shape of the upper layer of boards are known to the robot 5 and associated controller thereof. That is, a predetermined offset distance may be associated with each discovered edge based on the known dimensions of the perimeter shape, and these offset distances may be utilized in determining how much horizontal movement the EOAT 8 must travel away from the discovered corner for centering of the EOAT 8 relative to the perimeter shape of the upper layer of exposed boards. A single offset distance may be utilized with respect to the discovery of three different edges of the perimeter shape in similar fashion where the EOAT 8 is positioned horizontally to be centered between the opposing discovered edges and then offset away from the third discovered edge connecting the opposing discovered edges to center the EOAT 8 relative to the upper layer of the exposed boards. The discovery of all four perimeter edges of the upper layer of exposed boards allows for the center of the perimeter shape to be determined without being aware of the expected dimensions of the perimeter shape or any preset offsets. Once the perimeter shape of the upper layer of exposed boards is determined, it may be assumed that the remainder of the underlying bunk 7 includes each successive layer thereof having the same perimeter shape and center position such that the edges of each successive layer of the bunk 7 need not necessarily be discovered, thereby improving the cycle time for all layers of the bunk 7 encountered after the upper layer of the exposed boards is initially scanned and then removed upon the EOAT 8 addressing a new bunk 7.

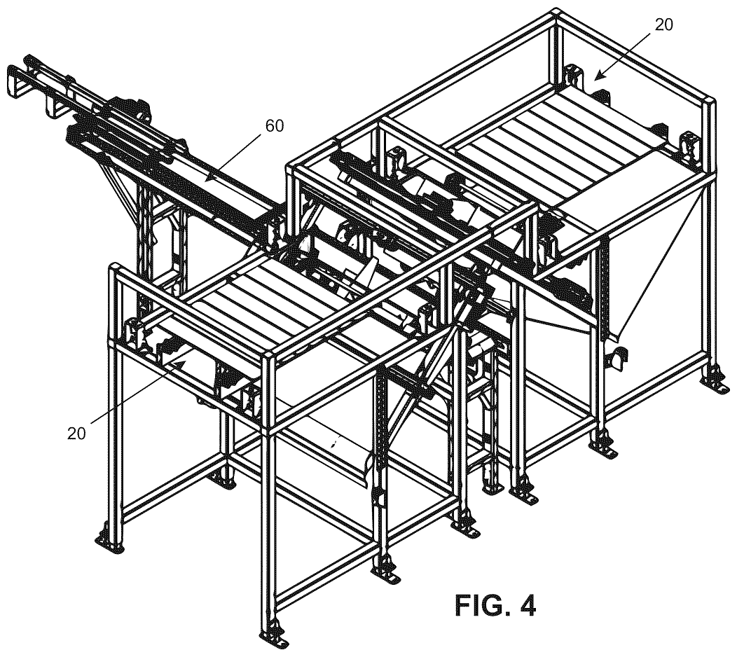

As shown in FIG. 4, the board loading cell 2 includes a substantially symmetric configuration including a pair of opposing board feed assemblies 20 that each feed the boards towards a centrally located transport conveyor 60. The transport conveyor 60 is configured to transport boards originating from each of the board feed assemblies 20 towards a board positioning mechanism 80 associated with a corresponding board hopper 90. Since each of the board feed assemblies 20 include substantially identical components and operate in the same manner, only the board feed assembly 20 depicted as the left-arranged board feed assembly 20 of FIG. 4 is described in detail hereinafter.

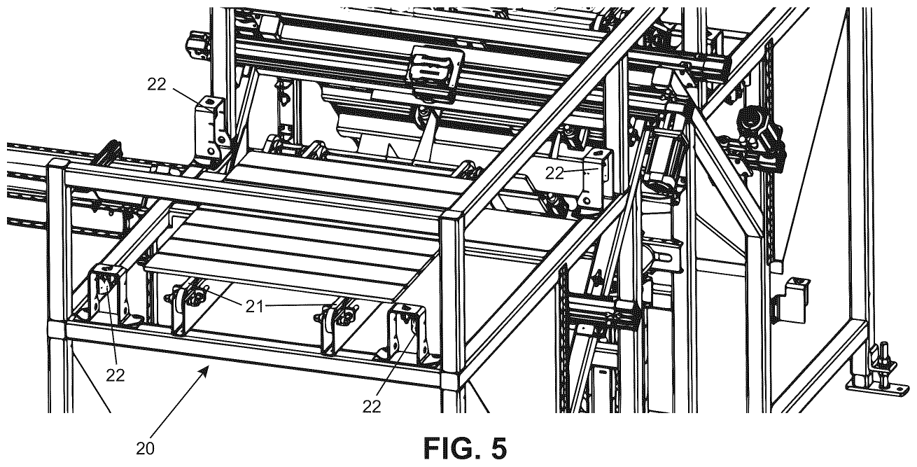

As shown in FIG. 5, the feed assembly 20 includes a horizontally arranged receiving conveyor 21 onto which a layer of the boards is disposed with the longitudinal dimension of each of the boards extending perpendicular to a direction of transport of the receiving conveyor 21. In the illustrated embodiment the receiving conveyor 21 includes two spaced apart belts that cooperate to orient the boards horizontally when extending between the belts, but alternative transport configurations and/or mechanisms may be utilized. The receiving conveyor 21 may be associated with one or more presence sensors 22 configured to determine whether any of the boards remain upon the horizontal surface of the receiving conveyor 21 when the robot 5 is about to place a new layer of the boards thereupon. Any form of suitable presence sensor 22 may be utilized while remaining within the scope of the present invention. As illustrated, each of the presence sensors 22 may be disposed adjacent a corner of the receiving conveyor 21 such that beams may be sent above the receiving conveyor 21 in an X-shape for determining whether any of the boards interfere with the beams. When boards are so detected, it can thus be determined that the receiving conveyor 21 is not available for a new layer of boards. The four presence sensors 22 may include two pairs of opposing sensors 22 with each opposing pair comprising an emitter and a receiver, or may include each of the sensors 22 being a combination of an emitter and a receiver, as desired.

The receiving conveyor 21 transports the layer of the boards in a direction towards the transport conveyor 60. The board feed assembly 20 includes a sorting region 25 disposed between the receiving conveyor 21 and the transport conveyor 60. The sorting region 25 is disposed along the pathway of a ramp 26 extending at a downward incline from an end of the receiving conveyor 21. The receiving conveyor 21 is configured to perform singulation of the boards being delivered to the sorting region 25 by selectively advancing a distance corresponding to only one of the boards falling by gravity over the transition from the horizontally arranged receiving conveyor 21 to the downwardly inclined ramp 26 with respect to each cycle of operation of the sorting region 25.

In the present example, the ramp 26 is formed by two ramp elements 26a spaced apart laterally by a distance less than the longitudinal dimension of the boards such that the boards can be supported to slide down the ramp elements 26a along a downwardly inclined plane formed by the cooperation of the upper surfaces of the ramp elements 26a. However, alternative ramp configurations may be utilized without departing from the scope of the present invention.

The ramp 26 includes, in a direction of progression downwardly from the receiving conveyor 21 toward the transport conveyor 60, a first stop position 27 and a second stop position 28. The first stop position 27 includes a first stop assembly 31 and the second stop position 28 includes a second stop assembly 32. In the illustrated embodiment, each of the stop assemblies 31, 32 is provided as a pair of stop elements 33 that are spaced apart laterally from one another with each of the stop elements 33 disposed at or adjacent one of the ramp elements 26a. Each of the stop elements 33 is formed by a shaft, rod, block, or the like configured to be actuated between an extended position and a retracted position relative to the pathway of the boards along the ramp 26. The actuation of the stop elements 33 may be performed by pneumatic actuators, although alternative forms of actuation may be utilized in actuating the stop elements 33 without departing from the scope of the present invention, including the use of hydraulic or electric actuating means, as non-limiting alternatives.

The pair of the stop elements 33 associated with either of the stop positions 27, 28 being actuated to the extended position corresponds to the stop elements 33 extending across the pathway for a corresponding one of the boards sliding downwardly along the ramp 26 such that the corresponding one of the boards is stopped to include a lower surface thereof, when so downwardly inclined along the ramp 26, resting on the pair of the spaced apart stop elements 33. The pair of the stop elements 33 associated with either of the stop positions 27, 28 being actuated to the retracted position corresponds to the stop elements 33 being retracted beyond the plane of the ramp 26 such that the corresponding board resting on the stop elements 33 may be advanced downwardly along the ramp 26 beyond the position of the stop elements 33 of the corresponding one of the stop positions 27, 28.

Each of the stop positions 27, 28 may be associated with one or more presence sensors 34 configured to determine whether one of the boards is instantaneously stopped at one of the stop positions 27, 28. Each of the presence sensors 34 may be directed towards the position of one of the boards when stopped at the respective one of the stop positions 27, 28. The presence sensor(s) 34 associated with the first stop position 27 may be associated with the singulation of the boards performed at the transition from the receiving conveyor 21 to the ramp 26 by preventing further advancement of the receiving conveyor 21 whenever it is determined by the presence sensor(s) 34 that a board has first slid down the ramp 26 to be stopped by the (extended) stop elements 33 of the first stop position 27 and before the next one of the boards has progressed far enough to slide down the ramp 26, thereby only introducing one board to the ramp 26 at a time. The advancement of the individual boards can then be controlled by actuation of the stop elements 33 at each of the stop positions 27, 28.

The first stop position 27 may alternatively be referred to as the inspection position 27 due to the use of at least one inspection sensor 35 that is configured to inspect each of the boards when stopped at the inspection position 27. Each of the inspection sensors 35 may be any form of sensor directed towards the board instantaneously stopped at the inspection position 27 that is capable of inspecting the corresponding board in a manner allowing for a sorting of the boards according to any desired set of sorting criteria. In the present invention, the sorting criteria may include determining whether each board is acceptably within certain specifications to proceed for use within a pallet, such as determining whether each board has the proper dimensions and/or is lacking certain flaws, and also determining whether each board is properly oriented along the ramp 26 to facilitate proper orientation of the board when reaching the transport conveyor 60 at the bottom of the sorting region 25.

In the present embodiment, the inspection position 27 of each feed assembly 20 includes two of the inspection sensors 35 with one of the inspection sensors 35 directed towards an upwardly facing surface of the board stopped at the inspection position 27 and another of the inspection sensors 35 directed towards an underside of the board stopped at the inspection position 27, wherein the underside of the board is only partially obstructed due to the ramp 26 being formed by two plate-like ramp elements 26a such that end portions and a middle portion of the stopped board may be inspected by the underside directed inspection sensor 35.

Each of the inspection sensors 35 of the illustrated embodiment includes a camera 36 slidably coupled to a rail or track 37 formed by a segment of a frame 20a of the feed assembly 20. Each of the rail or tracks 37 extends laterally across a width of the ramp 26 (perpendicular to the direction of sliding of the boards along the ramp 26) at a corresponding position above or below the support plane formed by the ramp 26. Each of the cameras 36 may be coupled to the corresponding rail or track 37 via a carriage assembly 38 having structure suitable for sliding each respective carriage assembly 38 relative to the corresponding rail or track 37 in order to cause the corresponding camera 36 to translate laterally in the direction of longitudinal extension of the board disposed at the inspection position 27. The lateral sliding of the camera 36 along the rail or track 37 may be necessary to scan the entirety of the board at the inspection position 27 at a desired resolution and/or from a desired distance from the board. The right portion of FIG. 5 showing the unlabeled second feed assembly 20 shows trapezoidal shapes expanding away from the cameras of the second feed assembly 20 to illustrate one possible viewing range of each of the cameras.

The inspection sensors 35 need not necessarily be vision-based (light based) cameras 36 and need not necessarily translate relative to the board being scanned to remain within the scope of the present invention. Any method of scanning each of the boards and sensing a shape, configuration, appearance, presence, and/or condition of each of the boards may be utilized at the inspection position 27 while remaining within the scope of the present invention, so long as the desired sorting criteria are able to be detected via the selected inspection sensors 35. For example, three-dimensional scanners may be utilized to scan a three-dimensional shape of each of the boards as one possible alternative. The inspection sensors 35 may also be provided as multiple different forms or types of sensors that cooperate in determining the shape, configuration, appearance, presence, and/or condition of each of the boards in a suitable manner.

Upon completion of the inspection of the board instantaneously stopped at the inspection position 27, the stop elements 33 of the inspection position 27 are moved to the retracted position to cause the just inspected board to slide by gravity along the ramp 26 until the just inspected board is once again stopped by the stop elements 33 of the second stop position 28, which are adjusted to the extended position when receiving one of the boards. As utilized herein, the second stop position 28 may alternatively be referred to as the queue position 28 due to the second stop position 28 primarily serving as a waiting position for each of the boards to rest before being selectively slid downwardly towards a board sorting mechanism 40 disposed at the bottom of the ramp 26 and end of the sorting region 25.

The controller of the board loading system 1 is configured to analyze the data collected via the inspection sensor(s) 35 while the just-scanned one of the boards rests at queue position 28 to determine whether the scanned board is acceptable for use within a to-be-assembled pallet and if so, whether the board was properly oriented at the inspection position 27 in a manner corresponding to the board sliding down the ramp 26 and falling onto the transport conveyor 60 while still maintaining the desired orientation. The desired orientation may include a specific one of the two major surfaces of each of the boards being upwardly exposed opposite the other of the major surfaces of the board that is resting upon the ramp 26, as can be differentiated by the data originating from the inspection sensor(s) 35.

The feed assembly 20 may be provided in the absence of the queue position 28 by maintaining each board at the inspection position 27 during the analysis of any data derived from the inspection sensor(s) 35 and then adjusting the first stop assembly 31 to advance the just-scanned board towards the board sorting mechanism 40 upon completion of said analysis. However, the use of the queue position 28 between the inspection position 27 and the board sorting mechanism 40 allows for a subsequent board to be inspected by the inspection sensor(s) 35 at the inspection position 27 during the time it takes the controller to make any sorting based determinations regarding the just-inspected board at the queue position 28 such that a through-put of the feed assembly 20 is increased via use of the queue position 28.

The board sorting mechanism 40 is adjustable between a first position corresponding to continued progression of the board waiting at the queue position 28 along and past the board sorting mechanism 40 in a direction towards the transport conveyor 60 as well as a second position corresponding to rejection of the board waiting at the queue position 28 such that the suspect board does not continue to progress towards insertion within an assembled pallet via the transport conveyor 60. The determination of whether the board sorting mechanism 40 is adjusted to the first position or the second position is based upon the analysis of the data originating from the inspection position 27 and the inspection sensor(s) 35, wherein acceptable boards meeting a desired set of specifications are allowed to progress beyond the board sorting mechanism 40 while unacceptable boards failing to meet a desired set of specifications and/or having certain detected flaws are removed from the feed assembly 20 via the board sorting mechanism 40.

The board sorting mechanism 40 includes a guide body 41 rotatably coupled to the frame 20a of the feed assembly 20 and selectively actuatable to rotate about an axis of rotation thereof for adjusting the board sorting mechanism 40 between the described first and second positions thereof. The guide body 41 defines a guide surface 42 of the board sorting mechanism 40 configured to be arranged substantially continuous with the plane of sliding of the boards along the ramp 26 when the board sorting mechanism 40 is rotatably adjusted to the first position thereof. That is, when the board sorting mechanism 40 is in the first position, the guide surface 42 is arranged substantially parallel and co-planar to the plane formed by the cooperation of the upper surfaces of the laterally spaced apart ramp elements 26a of the ramp 26 with the guide surface 42 extending a sufficient distance in the direction of sliding of the boards along the sorting region 25 such that the boards can slide from the end of the ramp 26 to a leading end of the guide surface 42 and then from a trailing end of the guide surface 42 to the transport conveyor 60.

In the presently illustrated embodiment, the guide body 41 includes a pair of laterally spaced apart and plate-like guide elements 43, which are substantially similar in configuration to the ramp elements 26a of the ramp 26. When the board sorting mechanism 40 is in the first position, the guide surface 42 of the guide body 41 is formed by the cooperation of the upper surfaces 43a of the guide elements 43, each of which is arranged to extend between the end of the ramp 26 and the transport conveyor 60 on the same plane as the support surface of the ramp 26.

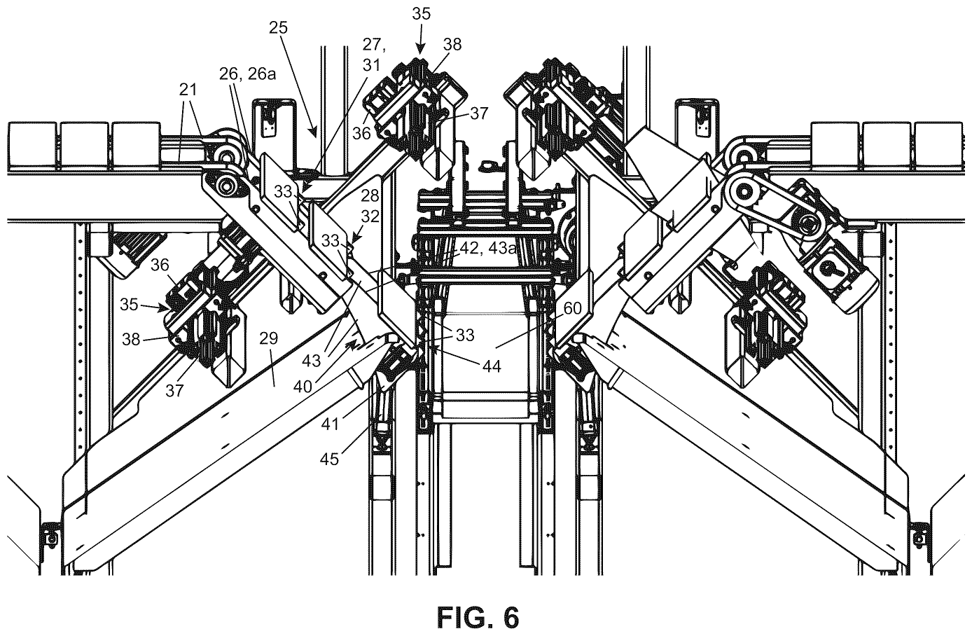

Adjustment of the board sorting mechanism 40 from the first position to the second position thereof includes the guide body 41 being rotated about the axis of rotation thereof such that the guide surface 42 formed by the guide body 41 is rotated away from the support plane of the ramp 26 in a direction towards the transport conveyor 60, which corresponds to the labeled guide elements 43 of FIG. 6 rotating in the clockwise direction with the axis of rotation of the guide body 41 disposed adjacent an edge of the transport conveyor 60. The rotation of the guide body 41 in the specified rotational direction results in the formation of a gap (not shown) between the end of the ramp 26 and the transport conveyor 60 with the guide elements 43 forming a backstop at the end of the gap.

The board sorting mechanism 40 is adjusted to the second position when the analysis of the data derived from the inspection sensor(s) 35 indicates that the just-inspected board is unacceptable and thus must be removed from the feed assembly 20 before progressing for use in a pallet. The rotation of the guide body 41 away from the ramp 26 results in a board passing by the queue position 28 falling off of the end of the ramp 26 and through the gap between the end of the ramp 26 and the underside of the guide body 41 following rotation thereof away from the ramp 26. The feed assembly 20 includes a removal ramp 29 disposed at an incline below the described gap such that any rejected boards are caused to slide down the removal ramp 29 towards a repository for the rejected boards. The removal ramp 29 may include an alternative inclination from that of the ramp 26 to cause each of the rejected boards to slide in a downward direction away from the transport conveyor 60. The removal ramp 29 may include slots for receiving portions of the guide elements 43 therein when the board sorting mechanism 40 is adjusted between the first and second positions.

The board sorting mechanism 40 also includes a third stop assembly 44 integrated therein that operates in substantially the same manner as the stop assemblies 31, 32, wherein the third stop assembly 44 includes a pair of spaced apart stop elements 33 that are (pneumatically) actuatable between retracted and extended positions. In contrast to those of the first and second stop assemblies 31, 32, the stop elements 33 of the board sorting mechanism 40 are coupled to the guide body 41 to rotate in unison therewith, rather than being fixed relative to a stationary structure such as the ramp elements 26a. More specifically, each of the guide elements 43 includes one of the stop elements 33 (and corresponding actuator thereof) coupled thereto adjacent the end of the upper surface 43a thereof that is disposed towards the outer edge of the transport conveyor 60. Each pairing of one of the upper surfaces 43a and one of the stop elements 33 (when in the extended position thereof) forms an L-shaped surface against which a board sliding along the guide surface 42 can rest, wherein this L-shaped surface is maintained during rotation of the guide body 41 about the axis of rotation thereof to support two perpendicular arranged surfaces of the corresponding board.

When the analysis of the data originating from the inspection of one of the boards indicates that the board requires flipping over (180 degree rotation), the guide body 41 is rotated to the first position (causing the guide surface 42 formed by the upper surfaces 43a to be continuous and co-planar to the support surface of the ramp 26) and the stop elements 33 of the third stop assembly 44 are adjusted to the extended (stopping) positions thereof. The stop elements 33 of the queue position 28 are adjusted to the retracted position to cause the board at the queue position 28 in need of flipping to slide from the end of the ramp 26 and onto the guide surface 42 of the board sorting mechanism 40 before coming to a stop against the third stop assembly 44. The board sorting mechanism 40 is then rotatably adjusted from the first position to the second position to cause the board resting against the stop elements 33 to invert during delivery to the upwardly exposed surface of the transport conveyor 60. The board sorting mechanism 40 is accordingly configured to sort the boards according to whether the boards are acceptable and correctly oriented, acceptable and in need of reorientation, or unacceptable and in need of rejection from the feed assembly 20.

The board sorting mechanism 40 of the present invention is rotatably actuated between the first and second positions thereof via use of a linear actuator 45 having a first end rotatably coupled to the guide body 41 and a second end rotatably coupled to the frame 20a of the feed assembly 20. The linear actuator 45, which may be a pneumatic actuator, is configured to be selectively extendable and retractable to increase or decrease a length of the linear actuator 45. A lengthening of the linear actuator 45 leads to rotation of the guide body 41 in a manner resulting in adjustment of the board sorting mechanism 40 from the first position to the second position thereof, whereas a shortening of the linear actuator 45 reverses this rotation and adjusts the board sorting mechanism 40 from the second position back towards the first position. However, alternative structures or devices for causing the rotation of the guide body 41 may be utilized while remaining within the scope of the present invention.

The transport conveyor 60 may be any form of conveyor mechanism for transporting the boards towards the board positioning mechanism 80, including a belt conveyor. The transport conveyor 60 may include tapered walls or guides for orienting and positioning the boards as they approach the board positioning mechanism 80. Where the board loading cell 2 has the two feed assemblies 20 feeding into a single transport conveyor 60, the timing of the passage of the boards past each of the respective board sorting mechanisms 40 may be selected to ensure that the boards are arranged in a single-file arrangement along the transport conveyor 60 absent any lengthwise overlaps of the boards, such as alternating which of the feed assemblies 20 delivers one of the boards to the transport conveyor 60 while allowing for each previous board to be transported a necessary distance to avoid an overlap of the boards along the transport conveyor 60.

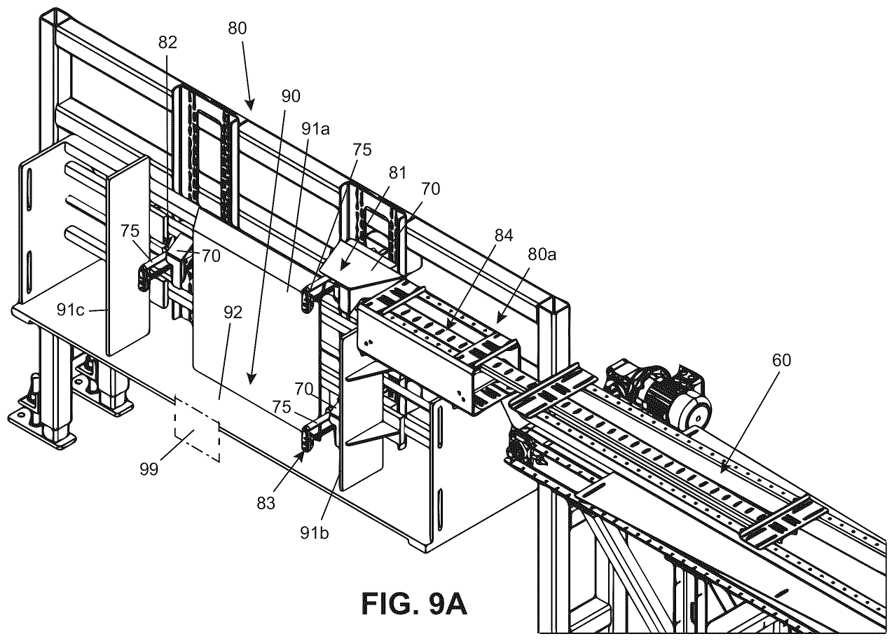

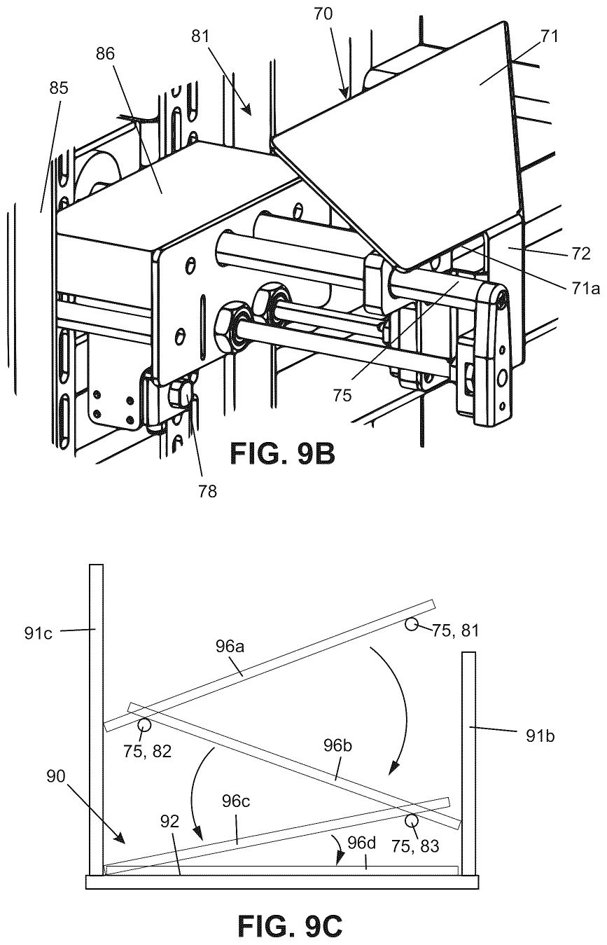

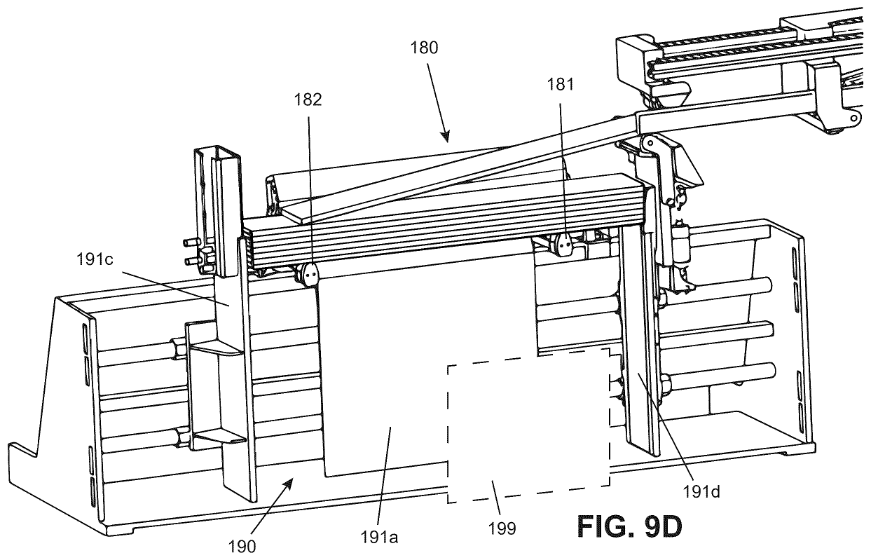

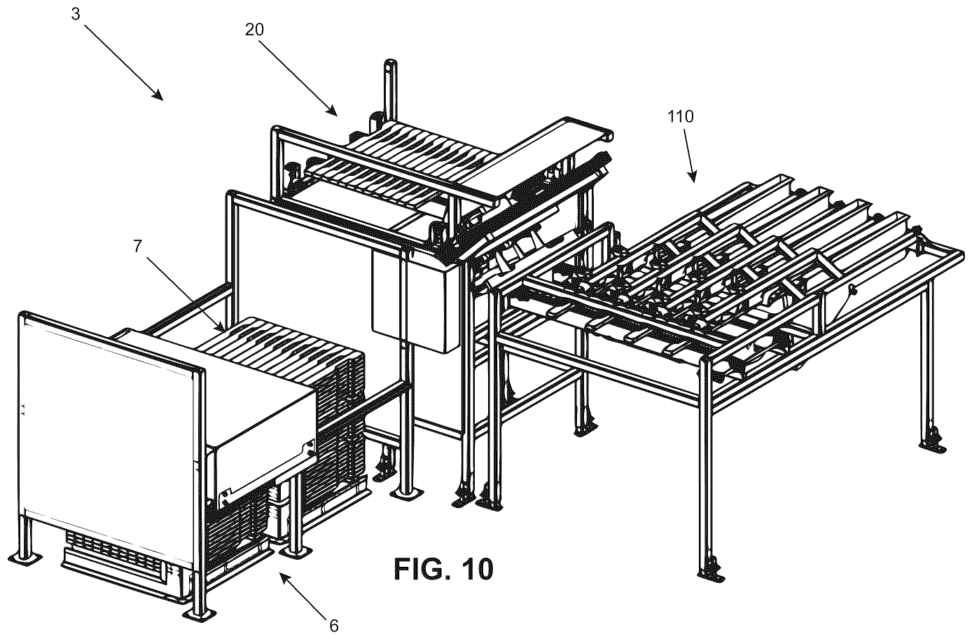

The board positioning mechanism 80 is configured to control (orient and position) a board when falling into the board hopper 90. Referring back to FIG. 1, the board positioning mechanism 80 and the board hopper 90 may be disposed adjacent a wall 99 or other delimiting surface associated with the system 1, and hence such components are not necessarily open-faced in the manner depicted in FIG. 9A. A representation of the position of the facing and delimiting surface of the wall 99 is shown in FIG. 9A for context. The hopper 90 includes a base surface 92 and a plurality of guide walls 91a, 91b, 91c for ensuring a desired position and orientation of the boards as they accumulate in the hopper 90. The base surface 92 is horizontally arranged along a bottom of the hopper 90 and the guide walls 91a, 91b, 91c extend vertically upwardly from the base surface 92 and are arranged along three adjacent sides of the boards as they accumulate within the hopper 90, wherein the wall 99 is arranged along the fourth of the sides of the boards. The boards accumulate in the hopper 90 while arranged to extend longitudinally in the direction of travel of the boards along the transport conveyor 60 with one of the major surfaces of each of the boards (extending on a plane in the width and length directions of the board) resting horizontally along the base surface 92 or an underlying one of the horizontally arranged boards.

The guide wall 91a is disposed on a plane extending in the longitudinal (horizontal) and thickness (vertical) directions of the boards as they accumulate within the hopper 90, which is parallel to, spaced apart from, and opposite that of the wall 99 to cause the guide wall 91a to cooperate with the wall 99 to define a width dimension of the hopper 90 substantially similar to and slightly larger than the width dimension of the instantaneously stacking boards to allow for proper stacking thereof within the hopper 90. The guide wall 91a may be adjustable in position relative to the wall 99 to accommodate boards of different thicknesses, such as 3.5 in and 5.5 in thickness boards, as two non-limiting examples. The guide wall 91 a may also include an alignment wall 98 along the upper end thereof that is angled downwardly and laterally (in the width direction of the boards) towards the wall 99 until intersecting the planar and vertically arranged portion of the guide wall 91a in a manner such that any boards encountering the alignment wall 98 are directed to slide downwardly towards longitudinal alignment along the wall 99.

Each of the guide walls 91b, 91c are arranged on planes arranged in the width (horizontal) and thickness (vertical) directions of the boards as they accumulate in the hopper 90 with the guide walls 91b, 91c spaced apart from each other in the longitudinal dimension of the boards such that the guide walls 91b, 91c cooperate with each other to define a length dimension of the hopper 90 substantially similar to and slightly larger than the length dimension of the instantaneously stacking boards to allow for proper stacking thereof within the hopper 90. A position of one or both of the guide walls 91b, 91c with respect to the longitudinal direction of the stacked boards may be adjusted to adjust the longitudinal dimension of the hopper 90 for accommodating boards of different lengths.

The adjustment of the guide walls 91a, 91b, 9c may occur via any form, including one or more of the respective walls 91a, 91b, 91c being actuated in the described directions via a corresponding linear displacement actuator such as a pneumatic, hydraulic, or electric actuator, as desired. The adjustment of the guide walls 91a, 91b, 91c to accommodate the dimensions of the instantaneously stacking boards may include the controller of the system 1 utilizing the information determined regarding the boards at the feed assembly 20 and adjusting the guide walls 91a, 91b, 91c when necessary to accommodate such previously acquired measurements.

The board positioning mechanism 80 includes a positioning area 80a having a first positioning assembly 81, a second positioning assembly 82, and a third positioning assembly 83. The second positioning assembly 82 is spaced apart from the first positioning assembly 81 by the direction of transport of the transport conveyor 60 while also being disposed below the first positioning assembly 81 with respect to the vertical direction of gravity. The third positioning assembly 83 is spaced apart from the second positioning assembly 83 in a direction opposite the direction of transport of the transport conveyor 60 and is also disposed below the second positioning assembly 82 with respect to the vertical direction, thereby positioning the third positioning assembly 83 substantially below the first positioning assembly 81. The third positioning assembly 83 is also disposed above the base surface 92 of the hopper 90. The board positioning mechanism 80 as shown in FIG. 9A may include the use of the transport conveyor 60 to feed the boards to the positioning area 80a or may include an independent and contiguously positioned conveyor or the like, as desired, for driving movement of the boards onto the positioning area 80a. The board positioning mechanism 80 may include a guide structure 84 adjacent an entrance to the positioning area 80a that is configured to guide the boards by limiting a position and orientation thereof as they approach the first positioning assembly 81. The guide structure 84 may have guidance rollers (not shown) disposed laterally thereacross (in the width direction of the boards) on which the boards are supported when approaching the first positioning assembly 81, wherein the support surfaces of the guidance rollers are positioned along a plane configured to deliver each of the boards towards the first positioning assembly 81 at a desired height and incline.

Each of the positioning assemblies 81, 82, 83 includes substantially similar structure and operates in substantially similar fashion, hence description of specific operation of each of the positioning assemblies 81, 82, 83 is limited herein to that of the first positioning assembly 81 shown in isolation in FIG. 9B. The first positioning assembly 81 includes an alignment structure 70 and a support element 75 that are each independently adjustable in position with respect to the width direction of the boards, which corresponds to movement towards or away from the plane of the guide wall 91 and away or towards the plane of the wall 99. The adjustment of each of the alignment structure 70 and the support element 75 may be accomplished via respective linear actuators coupled to a frame 85 of the board positioning mechanism 80 at a position opposite the wall 99, which corresponds to the side of the hopper 90 defined by the guide wall 91a. More specifically, the linear actuators (not shown) may be housed within an actuator housing 86 coupled to the frame 85, whereby the alignment structure 70 and the support element 75 extend laterally outwardly from the actuator housing 86 across the pathway of the boards exiting the guide structure 84 with the lateral outward extension occurring in a direction towards the wall 99.

The alignment structure 70 includes a funnel wall 71 and a lateral wall 72 depending downwardly from a bottom of the funnel wall 71. The funnel wall 71 extends in the direction of travel/longitudinal direction of the boards while inclined laterally (in the width direction of the boards) downwardly in a manner causing any boards passing over the funnel wall 71 to be directed towards the plane of the wall 99 via sliding by gravity along the inclined surface of the funnel wall 71. In contrast, the lateral wall 72 is vertically arranged on a plane in the longitudinal and thickness directions of the boards as they encounter the lateral wall 72. The bottom of the funnel wall 71 includes an edge 71a that extends in the longitudinal direction/direction of travel of the boards beyond the lateral wall 72 to a position above a support surface of the support element 75 when the support element 75 is extended laterally outwardly beyond the edge 71a in the manner as depicted in FIG. 9B, which facilitates a handing off of each of the boards from the funnel wall 71 to the support surface of the support element 75 when so adjusted.

The lateral wall 72 is configured to be adjusted to be arranged at a lateral spacing from the wall 99 that is substantially similar to but slightly larger than the determined width of the board passing by the lateral wall 72 to allow for the board to fall beyond the bottom of the funnel wall 71 to a position where the board rests on the support surface of the support element 75 while also being disposed laterally between the lateral wall 72 and the wall 99. The adjustment of the lateral wall 72 occurs in conjunction with the adjustment of the entirety of the alignment structure 70 via actuation of the corresponding linear actuator. The vertically arranged and planar surface of the guide wall 91a that partially defines the rectangular perimeter of the hopper 90 in which the boards are stacked may also be so adjusted to be substantially co-planar with the position of the lateral wall 72 to present the same lateral width between the vertical surface of the guide wall 91a and the wall 99 such that the boards maintain a substantially similar longitudinally arranged orientation throughout the stacking process. The board positioning mechanism 80 may be adjustable to accommodate boards of varying widths via the alignment structure 70 being adjustable to a plurality of different positions corresponding to different widths of the boards, wherein each of these plurality of different operational positions would correspond to lateral adjustment of the alignment structure 70 until the bottom of the funnel wall 71 and/or the lateral wall 72 is spaced apart from the wall 99 to suitably accommodate the instantaneous board therein, such as adjusting to a spacing slightly greater than the width of the instantaneous board.

The support element 75 is adjustable between a retracted (first) position and an extended (second) position via the corresponding linear actuator thereof. The retracted position of the support element 75 corresponds to any lateral/width position of the support element 75 whereby the support surface thereof is not disposed laterally outwardly beyond the edge 71a of the funnel wall 71 and the lateral wall 72, thereby causing any portion of a board encountering the alignment structure 70 to fall by gravity past the position of the support element 75 with the board positioned laterally between the lateral wall 72 and the vertical surface of the guide wall 91a to one side and the wall 99 to the other side. In contrast, the extended position of the support element 75 includes the support element 75 being actuated to a position wherein the support surface of the support element 75 is disposed laterally outwardly beyond the edge 71a of the funnel wall 71 and the lateral wall 72 for occupying a majority of the lateral gap present between the lateral wall 72 and the wall 99 in a manner wherein a portion of the overpassing board may be supported on the support element 75. The support element 75 may include at least the support surface thereof having a semi-cylindrical shape to cause any boards passing over the support surface to be able to pivot and maintain engagement with the support surface with respect to various different inclinations of the boards as they fall and pivot within the board positioning mechanism 80.

The first positioning assembly 81 further includes a board level sensor 78 for determining whether the boards accumulating within the hopper 90 have built up to a level of the corresponding sensor 78, thereby indicating that the corresponding first positioning assembly 81 is no longer in need of use for properly stacking the boards without undesired flipping or other misorientations of the boards. The board level sensor 78 may utilize a beam that is blocked/reflected when the level of the boards reaches the level of the board level sensor 78. When this level is reached, the support element 75 may be readjusted to the retracted position throughout future cycles until the need for the support element 75 is determined to once again be necessary, such as upon the hopper 90 being emptied during use of a corresponding assembly mechanism removing boards from the stack, whereby the support element 75 will be repeated adjusted between the retracted and extended positions according to ordinary use of the board positioning mechanism 80. In FIG. 9B, the board level sensor 78 is disposed at a vertical position that is spaced apart vertically from the support surface of the support element 75 such that the boards will fall this distance upon the support element 75 of the first positioning assembly 81 being determined to no longer be in need of use.

In operation, the transport conveyor 60 delivers the boards through the guide structure 84 and to the first positioning assembly 81. At this time, the support element 75 of the first positioning assembly 81 is adjusted to the extended position for supporting a board thereon and the support element 75 of the second positioning assembly 82 is also adjusted to the extended position for supporting a board thereon. It is assumed that all alignment structures 70 of all of the positioning assemblies 81, 82, 83 as well as the vertical surface of the guide wall 91a are adjusted to lateral positions for accommodating the width of the instantaneously stacked boards. Continued advancement of the board eventually results in the board falling to a position where the board is resting on each of the support element 75 of the first positioning assembly 81 and the support element 75 of the second positioning assembly 82 while in an inclined configuration with an end thereof engaging the guide wall 91c, which is shown as position 96a in FIG. 9C.

The support element 75 of the first positioning assembly 81 is then adjusted to the retracted position while the support element 75 of the third positioning assembly 83 is adjusted to (or already in) the extended position to cause the end of the board supported by the support element 75 of the first positioning assembly 81 to fall by gravity to being supported by the support element 75 of the third positioning assembly 83 while also engaging the guide wall 91b, which is shown as position 96b in FIG. 9C, whereby the inclination of the board is reversed from position 96a. The support element 75 of the second positioning assembly 82 is then actuated to the retracted position to cause the end of the board supported by the support element 75 of the second positioning assembly 82 to fall by gravity to being supported by the base surface 92 of the hopper 90 or the uppermost one of a stack of boards forming on the base surface 92 of the hopper 90 while engaging the guide wall 91c, depending on the progress of the stacking process, as shown as position 96c in FIG. 9C. The board accordingly once again changes inclinations from positions 96b to 96c while progressing towards being stacked within the hopper 90. The support element 75 of the third positioning assembly 83 is then actuated to the retracted position to cause the board to fall to rest on the base surface 92 of the hopper 90 or the stack of boards disposed thereon, as shown by position 96d in FIG. 9C, whereby the boards are horizontally arranged.

As mentioned above, as the level of the boards on the hopper 90 increases, the board level sensor 78 of the third positioning assembly 83 may detect that a board has reached the level indicating use of the third positioning assembly 83 is no longer needed, and may then result in actuation of the support element 75 thereof to the retracted position to cease such use indefinitely. This same process may occur with respect to the second positioning assembly 82 and then the first positioning assembly 81 as the level of the boards increases within the hopper 90. It should be apparent that the board positioning mechanism 80 may include greater or fewer of the positioning assemblies 81, 82, 83 depending on the height of stacking desired within the hopper 90. It should also be apparent that as the stack of the boards increases in height the process of use of the positioning assemblies 81, 82, 83 includes the lowermost one of the assemblies 81, 82, 83 still in use being associated with the dropping of the boards to rest on top of the stack as described with reference to the dropping of the boards from positions 96c to 96d, as opposed to dropping one of the boards to an adjacent disposed one of the assemblies 82, 83.

Referring now to FIG. 9D, an alternative embodiment of the board positioning mechanism is illustrated and generally designated by reference numeral 180. The board positioning mechanism 180 is similar in many respects to the board positioning mechanism 80 described with reference to FIGS. 9A-9C, and like reference numerals are used to refer to like components where applicable with the addition of 100 thereto, except as otherwise noted. The board positioning mechanism 180 is configured to improve consistency of board orientation during stacking by supporting a plurality of boards simultaneously in a substantially rectangular cuboid configuration prior to depositing the boards into the hopper.

In contrast to the board positioning mechanism 80 of FIGS. 9A-9C, which utilizes multiple vertically offset positioning assemblies that sequentially support and release individual boards in alternating inclined orientations, the board positioning mechanism 180 includes only a first positioning assembly 181 and a second positioning assembly 182. The first and second positioning assemblies 181, 182 are disposed at a common vertical height adjacent an upper region of a hopper 190, and are spaced apart from one another in a longitudinal direction of the boards being stacked. Each of the positioning assemblies 181, 182 may utilize substantially the same structure and actuation mechanisms as the positioning assemblies 81, 82, 83 previously described, including the use of support elements movable between extended and retracted positions.

The positioning assemblies 181, 182 are arranged such that, when in their extended positions, the support elements thereof collectively define a substantially horizontal support plane for receiving boards delivered by a transport mechanism, such as the transport conveyor 60 or another suitable board delivery device. As boards are delivered to the board positioning mechanism 180, the boards are caused to land on and be simultaneously supported by both of the positioning assemblies 181, 182 at opposing longitudinal end regions of the boards.

Unlike the embodiment of FIGS. 9A-9C in which individual boards are transferred between positioning assemblies while being inclined in alternating directions, the board positioning mechanism 180 allows multiple boards to accumulate and stack on the positioning assemblies 181, 182 while remaining substantially parallel to one another. As additional boards are delivered, the boards collectively form a rectangular cuboid stack supported at opposite longitudinal ends by the positioning assemblies 181, 182.

The hopper 190 associated with the board positioning mechanism 180 includes surrounding guide walls 191a, 191b, 191c and an opposing wall 199, which together define an enclosure that limits lateral and longitudinal movement of the boards during stacking. These surrounding walls constrain the stack of boards such that individual boards are inhibited from rotating, tipping, or deviating from the rectangular cuboid shape formed by the stack. The interaction between adjacent boards within the stack further resists undesired reorientation, thereby increasing stability and repeatability of the stacking process.

Once a desired number of boards has accumulated on the positioning assemblies 181, 182, or once a predetermined stack height has been reached, both positioning assemblies 181, 182 are actuated simultaneously to their retracted positions. Retraction of the positioning assemblies 181, 182 causes the entire stack of boards supported thereon to fall substantially vertically downward as a unit into the hopper 190 or onto a previously deposited stack of boards within the hopper. Because the boards are released simultaneously and remain constrained by the surrounding walls during descent, the stack maintains its rectangular cuboid shape and desired orientation during the drop.

The board positioning mechanism 180 thus provides improved orientation consistency relative to embodiments employing sequential inclined transfers of individual boards. By supporting and releasing multiple boards simultaneously from positioning assemblies located at a common height, the board positioning mechanism 180 reduces opportunities for individual boards to rotate, flip, or misalign, resulting in a more reliable and repeatable stacking process.

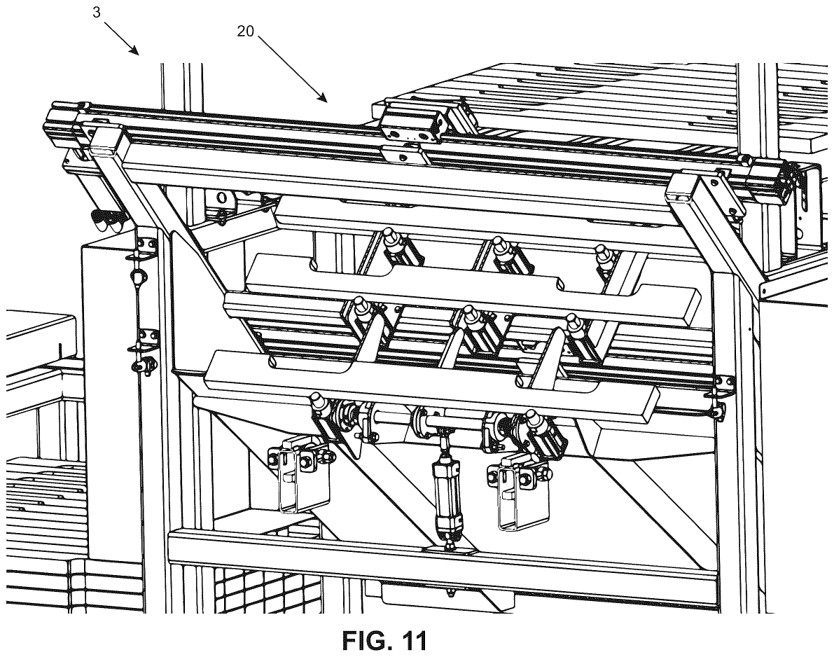

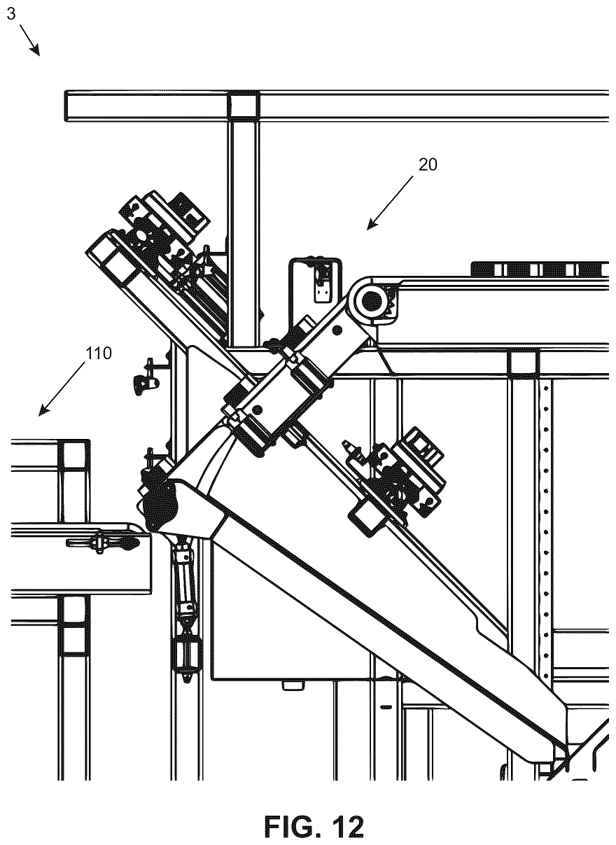

Referring now to FIG. 10, a portion of the stringer loading cell 3 is shown in isolation to better identify the relevant features thereof. The stringer loading cell 3 includes the use of a single feed assembly 20 that feeds the accepted and properly oriented boards to a board (stringer) positioning mechanism 110 according to another embodiment of the present invention, wherein the board positioning mechanism 110 may alternatively be referred to as the (stringer) funneling mechanism 110 based on the operation thereof. In contrast to the board positioning mechanism 80, which stacks the boards to lay horizontally, the board positioning mechanism 110 is configured to reorient the boards to stack while in a vertical arrangement. The feed assembly 20 of the stringer loading cell 3 is substantially identical to the feed assembly 20 of the board loading cell 2 with the exception of the stringer loading cell 3 being dimensioned and programmed for the sorting and delivery of the stringer boards rather than the deck boards, but otherwise includes substantially identical components that operate in substantially identical fashion to those of the feed assemblies 20 of the board loading cell 2, hence further description thereof is omitted. FIGS. 11 and 12 illustrate the nearly identical configuration of the feed assembly 20 of the stringer loading cell 3 while being unlabeled. One minor distinction relates to each of the stop assemblies as shown in FIG. 11 having three of the stop elements rather than two, but operation thereof remains the same as previously described.

The sorting mechanism of the stringer loading cell 3 delivers the acceptable boards directly to a transport conveyor 160 of the funneling mechanism 110 with the boards continuing to travel horizontally along the transport conveyor 160 away from the feed assembly 20. The sorting mechanism also ensure that each of the stringers is delivered to the funneling mechanism 110 while in the proper and desirable orientation, including the positioning of the notched sides of the stringers, such that the operations performed at the funneling mechanism 110 result in the proper orientation within a corresponding hopper or magazine for the stringers.

The transport conveyor 160 may be any form of supportive transport mechanism such as a chain conveyor on which the boards rest when laying in a substantially horizonal configuration. The transport conveyor 160 may include two or more laterally spaced apart conveyor elements 160a, such as multiple beams, plates, or similar structures each having a drive belt or chain associated therewith, such that the stringers can be approached from beneath by a roller conveyor assembly 115 configured to selectively extend through the lateral spaces present between adjacent ones of the conveyor elements 160a, as explained hereinafter. A portion of a frame 112 of the funneling mechanism 110 also extends above the pathway of the transport conveyor 160 to allow for interaction with the stringers from a position thereabove as the stringers are positioned by the transport conveyor 160.

The funneling mechanism 110 includes a plurality of funneling stations 120 arranged along the direction of transport of the transport conveyor 160. Each of the funneling stations 120 is associated with a corresponding stringer hopper or magazine (not shown) into which the stringers are loaded according to the present disclosure. The funneling mechanism 110 is shown as having four of the funneling stations 120, but any number of the funneling stations 120 may be utilized while remaining within the scope of the present invention.

Each of the funneling stations 120 includes a plurality of stop elements 122 disposed laterally across the pathway of the stringers as they move away from the feed assembly 20 along the transport conveyor 160. As shown, each of the stop elements 122 may be coupled to the frame 112 at a position above a corresponding one of the conveyor elements 160a and may be actuatable between an extended position where the corresponding stop element 122 extends downwardly into the pathway of the transport conveyor 160 for stopping one of the stringers at the desired one of the funneling stations 120 and a retracted position where the corresponding stop element 122 is retracted away from the pathway of the transport conveyor 160 for allowing passage of one of the stringers to a downstream arranged one of the funneling stations 120. However, alternative positions and orientations of approach of the stop elements may be utilized while remaining within the scope of the present invention.

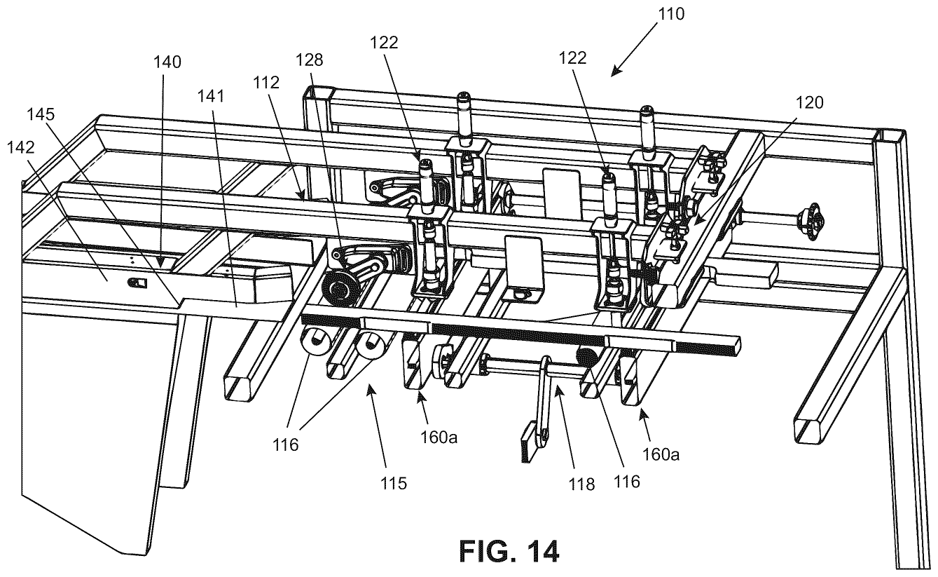

The actuation of the stop elements 122 includes all of the stop elements 122 of the corresponding funneling station 120 being adjusted to the retracted or extended positions concurrently to either stop or allow passage of one of the stringers, although the depiction of the stop elements 122 in FIG. 14 shows the leftmost stop element 122 being in the retracted position and the rightmost stop element 122 being in the extended position to show the distinction between the two different positions of each of the stop elements 122 (in opposition to normal operation of the funneling station 120 as described herein). Each of the funneling stations 120 may also be associated with a corresponding presence sensor directed at the position of the stringers when stopped by the corresponding set of the stop elements 122 for determining which of the funneling stations 120 instantaneously have one of the stringers stopped thereat.

The transport conveyor 160 may transport the stringers towards the funneling stations 120 until each of the funneling stations 120 be utilized has one of the stringers stopped thereat. This may include a stringer first being delivered to the farthest funneling station 120 and each subsequent stringer being stopped at the next closest of the (currently operated) funneling stations 120 until all desired funneling stations 120 have a stopped one of the stringers positioned thereat. Next, the previously mentioned roller conveyor assembly 115 is raised from below the transport conveyor 160 to engage and slightly lift an underside of the stopped stringers such that support of the stringers is transferred from the support surface of the transport conveyor 160 to a support surface of the roller conveyor assembly 115. As shown in FIG. 14, the lifting of the roller conveyor assembly 115 may be performed by a lift mechanism 118 coupled to an underside of the transport conveyor 160 or to the frame 112 of the funneling mechanism 110.

The roller conveyor assembly 115 includes a plurality of rollers 116 spaced apart from each other by the longitudinal direction of each of the stringers when stopped at each of the funnel stations 120, which is perpendicular to the direction of transport of the transport conveyor 160. Each of the rollers 116 is cylindrical in shape and includes an axis of rotation that is arranged perpendicular to the longitudinal direction of each of the stringers. When the roller conveyor assembly 115 is lifted, the instantaneously uppermost surfaces of the rollers 116 cooperate to form a support surface on which each of the stringers is supported when raised slightly from the support surface of the transport conveyor 160. At least one of the rollers 116 may be coupled to an actuator, wherein the actuator is configured to rotate the corresponding roller 116 and/or is configured to rotate a plurality of the rollers 116 via a transfer of rotational movement from the actuator to each of the associated rollers 116 such that each of the stopped stringers are caused to translate in a direction of travel of the roller conveyor assembly 115 that is parallel to the longitudinal direction of the stringers and perpendicular to the direction of transport of the transport conveyor 160. Each of the funneling stations 120 may also be associated with a biased roller 128 disposed above the stop position for one of the stringers at the corresponding funneling station 120 with the biased roller 128 configured to engage an upper surface of the underlying stringer during the lifting of the stringer via the raising of the roller conveyor assembly 115. The biased roller 128 may include a spring or other biasing element to cause the biased roller 128 to apply a downward force to the corresponding stringer upon contact therewith to ensure that the stringer is properly frictionally engaging the rollers 116 of the roller conveyor assembly 115 such that the rotation of the rollers 116 is properly transferred to the translation of the stringers in the disclosed direction of travel.

The present invention includes a single roller conveyor assembly 115 associated with all of the funneling stations 120 via each of the rollers 116 extending across the underside of the stringers of all disclosed funneling stations 120. However, the funneling mechanism 110 may alternatively include multiple different independently operated roller conveyor assemblies 115 distributed to the funneling stations 120 in any desired manner.

The disclosed roller conveyor assembly 115 is one exemplary form of conveyor assembly that may be utilized in causing each of the stringers stopped at one of the funneling stations 120 to translate in the longitudinal direction thereof, wherein alternative structures and methods from those shown and described may be utilized in causing the translation of the stringers without departing from the scope of the present invention. For example, the conveyor assembly may be formed by any form of conveyor element configured to selectively engage a major surface of a stopped one of the boards for causing translation thereof, including the use of one or more drive belts, chain conveyors, or the like. The conveyor assembly is also not necessarily limited to being raised to transfer support of the board thereto, and may alternatively and/or additionally include any number of the conveyor elements approaching the stringer from above for making the necessary frictional contact with the board for causing the described translation thereof. In any event, the corresponding conveyor assembly is configured to cause each of the stringers to be translated in the longitudinal direction thereof via actuation of the corresponding conveyor elements in accordance with the present disclosure.

Each of the funneling stations 120 includes a corresponding funneling structure 140 disposed adjacent the transport conveyor 160 and configured to receive one of the stringers being rolled via the roller conveyor assembly 115. Each funneling structure 140 may be associated with some form of stringer presence sensor to determine whether the funnel structure 140 is free of a stringer from a prior cycle and is thus ready for the next stringer to be delivered thereto.

Each of the funneling structures 140 includes a base surface 141 on which one of the stringers is slid when transferred thereto by the roller conveyor assembly 115, a vertically arranged first guide wall 142 extending along a first lateral side of the base surface 141, and a vertically arranged second guide wall 143 extending opposite the first guide wall 142 along a second lateral side of the base surface 141. The first guide wall 142 extends longitudinally in a direction parallel to the direction of travel of the stringers sliding along the base surface 141 and the second guide wall 143 extends longitudinally in a direction inclined inwardly towards the first guide wall 142 as the second guide wall 143 progresses away from the roller conveyor assembly 115 and the transport conveyor 160. The inward tapering of the second guide wall 143 ensures that the stringers are directed towards the first guide wall 142 as they progress along the base structure 141.

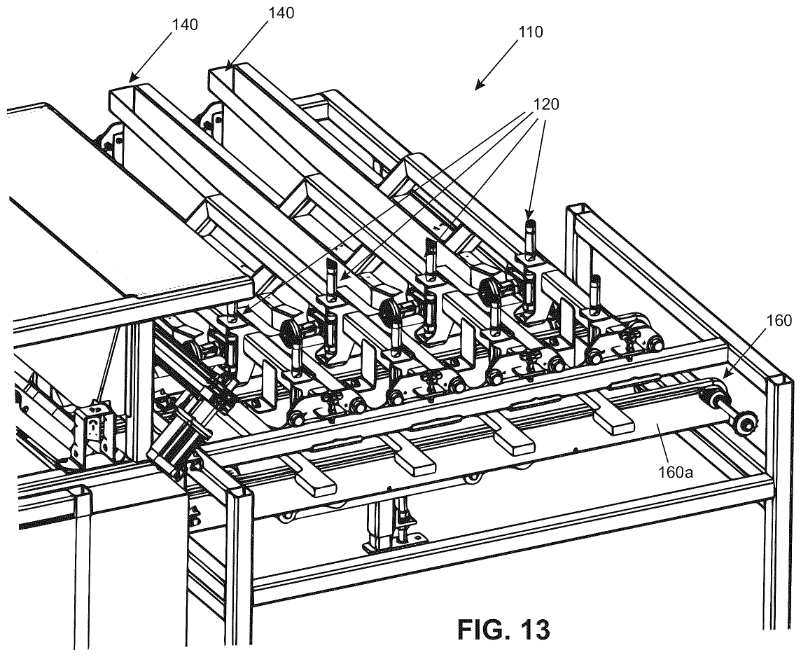

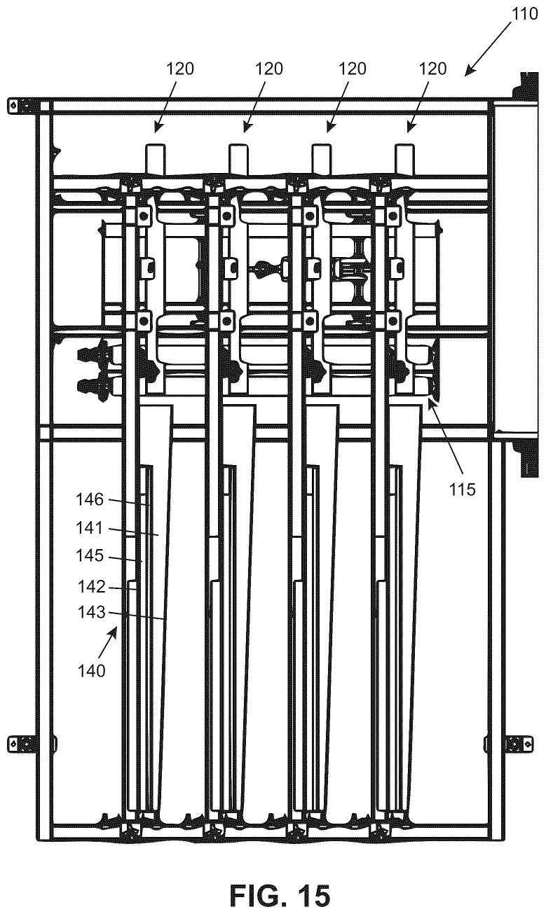

A stringer slot 145 is formed in the base surface 141 along the first guide wall 142 and includes a width that is less than a width of each of the stringers and more than a thickness of each of the stringers. The width of the stringer slot 145 may be about half of the width of each of the stringers to ensure that the stringers are biased to fall through the stringer slot 145 by means of a center of mass of each of the stringers eventually being positioned over the stringer slot 145 once a length of the stringer is aligned with a length of the stringer slot 145. The longitudinal edge of the stringer slot 145 opposite the first guide wall 142 may be formed by a downwardly inclined ramp surface 146 aiding in causing the initial tipping of each of the stringers and then guiding each of the stringers to fall into the stringer slot 145 at a desired orientation, such as notch up (which would result from the illustrated configuration of the stringers in FIGS. 13-15) or notch down (a possible alternative for different circumstances).

The funneling structure 140 operates by the second guide wall 143 biasing movement of the stringer towards the first guide wall 142 and the stringer slot 145 as the stringer is slid along the base surface 141 away from the roller conveyor assembly 115. The stringer eventually reaches a position where the stringer is longitudinally aligned to fall through the stringer slot 145. At this same position, the stringer has been guided by the second guide wall 143 to a position where the stringer begins to tilt about an edge of the stringer slot 145 transitioning to the ramp surface 146 such that a controlled 90 degree rotation of each of the stringers is achieved as the stringers pass through the stringer slot 145. Each stringer slot 145 in turn leads to a corresponding stringer hopper or magazine of a corresponding mechanism such as a nailing mechanism, which is disposed beneath each of the stringer slots 145 to receive one of the stringers as the preselected orientation.

The funnel structure 140 may be associated with one or more presence sensors for determining when the corresponding stringer hopper or magazine has become full or reached a specific height. Such sensors may include a presence sensor directed into the stringer slot 145 to ensure that the stringer slot 145 is clear of stringers or may include a presence sensor directed at a top or upper position of the stringer hopper or magazine.

From the foregoing description, one ordinarily skilled in the art can easily ascertain the essential characteristics of this invention and, without departing from the spirit and scope thereof, can make various changes and modifications to the invention.

What is claimed is:

1. A board loading system comprising:
a first board loading cell including:
a robot having an end of arm tool configured to grasp and transport at least one board;
a feed assembly including:
a receiving conveyor configured to receive the at least one board grasped and transported by the robot;
a sorting region individually receiving one of the boards from the receiving conveyer, the sorting region including:
a ramp having an inspection position where an inspection sensor inspects the one of the boards received from the receiving conveyor; and
a board sorting mechanism configured to sort the one of the boards having been scanned by the inspection sensor according to the scanning results associated therewith, the sorting of the one of the boards including allowing passage of the one of the boards when determined to be acceptable and properly oriented, reorienting and allowing passage of the one of the boards when determined to be acceptable and improperly oriented, and rejecting the one of the boards for removal from the feed assembly when determined to be unacceptable;
a transport conveyor configured to transfer the acceptable boards towards an assembly mechanism associated with the board loading system.

2. The system of claim 1, wherein the ramp is downwardly inclined and includes a first stop position defining the inspection position and a second stop position downstream of the inspection position with respect to sliding motion of the one of the boards along the ramp, the first and second stop positions being selectively actuatable to control the sliding motion of the one of the boards along the ramp.

3. The system of claim 1, wherein the inspection sensor includes at least one camera configured to scan at least one of an upper surface and/or a lower surface of the one of the boards while the one of the boards is stopped at the inspection position.

4. The system of claim 1, wherein the board sorting mechanism includes a rotatable guide body movable between a first position defining a continuation of a support plane of the ramp and a second position defining a gap along the ramp that causes the one of the boards to be rejected from the feed assembly when falling therethrough.

5. The system of claim 4, wherein the rotatable guide body includes at least one stop element configured to temporarily support the one of the boards during rotation of the guide body to invert the one of the boards from an improperly oriented orientation to a properly oriented orientation.

6. The system of claim 1, wherein a first hopper for receiving the boards is associated with the assembly mechanism, and wherein the transport conveyor transfers the acceptable boards towards a board positioning mechanism configured to stack the boards within the first hopper.

7. The system of claim 1, wherein the feed assembly further includes a queue position downstream of the inspection position with respect to sliding motion of the one of the boards along the ramp, the queue position being configured to temporarily hold the one of the boards while inspection data associated with the one of the boards is analyzed.

8. A board positioning mechanism comprising:
a hopper in which boards are stacked; and
first and second positioning assemblies disposed at an upper region of the hopper or above the hopper, wherein each of the first and second positioning assemblies includes a support element adjustable between a first position for supporting boards thereon and a second position for allowing the boards to fall by gravity, and wherein the first and second positioning assemblies are disposed at substantially the same vertical height and spaced apart from one another in a longitudinal direction of the boards.

9. The board positioning mechanism of claim 8, wherein the first and second positioning assemblies are configured to simultaneously support opposing longitudinal end portions of a plurality of boards such that the plurality of boards forms a stacked rectangular cuboid configuration while supported by the first and second positioning assemblies.

10. The board positioning mechanism of claim 9, wherein the first and second positioning assemblies are configured to be retracted simultaneously to cause the plurality of boards to fall together as a unit into the hopper while maintaining the rectangular cuboid configuration.

11. The board positioning mechanism of claim 9, wherein the hopper includes a plurality of surrounding guide walls configured to constrain lateral and longitudinal movement of the plurality of the boards while supported by the first and second positioning assemblies, thereby inhibiting rotation or misorientation of individual boards within the stack of the plurality of the boards.

12. The board positioning mechanism of claim 11, wherein each of the first and second positioning assemblies includes an alignment structure configured to position the boards relative to the surrounding guide walls prior to stacking.

13. A board funneling mechanism comprising:
a transport conveyor transporting boards with the boards arranged to extend longitudinally in a direction perpendicular to the direction of travel of the transport conveyor; and
a funneling station disposed along the pathway of the transport conveyor, the funneling station comprising:
a stop element configured to stop one of the boards being transported by the transport conveyor at the funneling station;
a conveyor assembly actuatable to selectively cause the stopped board to be translated in the longitudinal direction thereof; and
a funneling structure aligned longitudinally with the board when stopped at the funneling station, whereby the conveyor assembly selectively causes the stopped board to be translated in the longitudinal direction thereof into the funneling structure, wherein the funneling structure is configured to orient the board for upright stacking within a hopper disposed below the funneling structure.

14. The board funneling mechanism of claim 13, wherein the conveyor assembly includes at least one conveyor element configured to selectively engage a major surface of the stopped board to cause the translation of the stopped board in the longitudinal direction thereof.

15. The board funneling mechanism of claim 14, wherein the at least one conveyor element is configured to be raised or lowered relative to the major surface of the board to cause the selective engagement of the at least one conveyor element with the major surface of the board.

16. The board funneling mechanism of claim 14, wherein the at least one conveyor element is configured to be lifted above a support surface of the transport conveyor to transport support of the board stopped at the funneling station from the support surface of the transport conveyor to a support surface of the at least one conveyor element.

17. The board funneling mechanism of claim 16, wherein the conveyor assembly is a roller assembly and the at least one conveyor element is a roller.

18. The board funneling mechanism of claim 17, wherein actuation of the roller of one of the conveyor elements causes the stopped board to be translated in the longitudinal direction thereof into the funneling structure 19.The board funneling mechanism of claim 13, wherein the board funneling mechanism includes a plurality of the funneling stations each having a respective stop element and respective funneling structure aligned therewith.

20. The board funneling mechanism of claim 13, wherein the conveyor assembly is common to all of the funneling stations such that each of the boards stopped at one of the funneling stations is directed towards the corresponding funneling structure via actuation of the conveyor assembly.
